(19) United States
(12) Patent Application Publication
(10) Pub. No.: US 2011/0123752 A1
(43) Pub. Date: May 26, 2011

(54) Thermoplastic Shelf Talker Labels

(75) Inventors: Mathew S. Mellis, Strongsville, OH (US); Dirk Lovelace, Spartansburg, SC (US); Vance P. Mattison, Clinton, SC (US); John Walsh, Medina, OH (US)

(73) Assignee: AVERY DENNISON CORPORATION, Pasadena, CA (US)

(21) Appl. No.: 12/833,866

(22) Filed: Jul. 9, 2010

Related U.S. Application Data
(60) Provisional application No. 61/224,482, filed on Jul. 10, 2009.
(60) Provisional application No. 61/239,523, filed on Sep. 3, 2009.

(51) Int. Cl. G09F 3/00; B32B 38/04; B32B 33/00

(52) U.S. Cl. 428/40.1; 428/43; 156/253

(57) ABSTRACT

A sheet of printed labels where the facestock and the liner are microperforated around and through the depth of the perimeter of each of the labels provided in the sheet of printed labels. An attachment pattern or feature is provided on one or both of the facestock or shelf area to facilitate attachment of the shelf taker. Combining the microperforations along the perimeter with a connecting smooth full cut portion provides a smooth full cut for ease of removal of the label from the sheet and removal of the facestock from the liner.

### CROSS-REFERENCE TO RELATED APPLICATION

The present application claims priority from U.S. Provisional Application No. 61/224,482 filed Jul. 10, 2009, and U.S. Provisional Application No. 61/239,523 filed Sep. 3, 2009, both of which are incorporated herein by reference in their entireties.

### FIELD OF THE INVENTION

This invention relates to labels, and more particularly to thermoplastic film pressure sensitive constructions for advertising purposes, namely “shelf talkers.” More specifically the invention discloses a process of constructing a shelf talker that includes a novel arrangement of PET materials. The invention also discloses a process of removing and applying “shelf talker” labels to retail shelves or displays.

### BACKGROUND OF THE INVENTION

The typical retail market includes aisles of shelves on which different products are displayed. Each shelf includes an edge facing the consumer in which individual product labels are adhered. The typical shelf tag is small such that it fits along the edge and generally includes pressure sensitive adhesive on the back side of the label so that a bond forms with the edge.

A shelf talker is name given to a particular type of advertising tag that is used for promoting brand identity and information about the product, such as price, size, etc. displayed above. The shelf talker is generally larger than a shelf label and has a tab with additional information about the product. Shelf talkers are typically provided in groups of similar size on individual sheets of pressure sensitive adhesive protected by a Kraft based release liner. Additional information, including the specific product, size, and promotional price, is printed on each of the shelf talkers on an individual sheet using a suitable printer including thermal transfer, laser, and direct thermal printers. Shelf talkers are used most frequently to garner a potential customer's attention to alert them that a particular item is on sale.

As shelf talkers are intended to be temporary in nature, shelf talkers must be easy and economical to produce, install, and remove, and as well as being durable enough to withstand the intended application in a retail or wholesale advertising or marketing environment.

Traditional manufacture of pressure-sensitive adhesive stock for labels is performed by providing a layer of face material or a substrate for the label which is backed by a coating of pressure-sensitive adhesive. This label is subsequently covered by a release liner or carrier which is commonly a silicone or wax coated paper. The liner or carrier protects the adhesive during shipment and storage and allows for efficient handling and stiffness of an array of individual labels up to the point where the individual labels can be properly dispensed.

Traditional shelf talkers are normally made with a lay flat polycoated liner, from 80 to 95 lb per ream with a removable adhesive and a vinyl face stock that serves as the label substrate that contains fixed graphics and variable information that details the sale information. One of the more significant issues with a traditional shelf talker is reactive curling. Reactive curling occurs when a liner for a shelf talker absorbs moisture under dry or humid circumstances. The label can either curl inwardly on to itself or outwardly to the liner. When a label curls, it becomes difficult to read what is on the label without physically uncurling it to reveal the information on the label. Such curling fails to provide an aesthetic “billboard” to carry information to consumers. The use of a shelf talker is then limited to usage in areas that have controlled environments (e.g. temperature, humidity). Reactive curl in the sheet can negatively impact digital printing of the product leading to jams in the feed mechanism thus reducing productivity as well as the scrap generated when the sheets are not imaged properly. Curl can also lead to issues with stacking and collating the sheets into books as even small amount of curl can impede binding of the imaged sheets.

Another issue of concern with sheets of labels is the occurrence of delamination during printing. Delamination happens when the labels are pre-cut prior to the printing process. The labels can delaminate or lift off from the liner while moving through the printing or imaging process. This can cause jams and contamination (such as when the exposed adhesive contacts the rollers of the device) within the machine resulting in costly downtime for the user for cleaning and maintenance.

The label sheet may also ooze adhesive from the edges while moving between rollers, photoreceptors or in an image fixation device such as a roll fuser, that is the pressure applied by the rollers can cause adhesive to seep out beyond the edges of the construction. One solution that has been utilized, allows for labels to remain adhered to the liner when the adhesive is placed properly away from the edge of the border of the label, thus keeping the adhesive from oozing out during the printing or imaging process.

Solving the printing reliability problem also poses a challenge in post printing since reliably adhering the label to the liner also causes difficulty for the end user to remove the label from the sheet. Microperforating labels along their perimeter allow the labels to be removed from the sheet.

Other difficulties that impact the usefulness of shelf talkers in certain applications relate to the use of these labels in other than room temperature environments, such as in a freezer section of a grocery store. The pressure sensitive adhesive used to apply the shelf talker may not adhere to the shelf and may fall off, thus leaving the shelf without an indicator or identifier of the item on the shelf. This may cause the retailer to have to clip the label to the shelf so that the label will remain in position and costs the retailer additional labor in creating these temporary fixes.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Disclosed is a sheet of printed labels that includes a PET (polyethylene terephthalate), having a polymeric or thermoplastic facestock with printed or imaged information on the facestock in discrete or predefined areas. A pattern of adhesive is applied on the back of the facestock and a liner cohesively attached to the adhesive where the facestock and the liner are microperforated. A shelf talker as presented herein constructed of PET avoids reactive curl and other drawbacks associated with prior art constructions.

The microperforations are generally around and through the depth of the perimeter of the label combined with a connecting smooth full cut portion which is void of microperforations. This provides a smooth full cut for ease of removal of the label from the sheet and removal of the facestock from the liner.

In another embodiment the facestock is face-cut allowing for peeling away the liner to a desired distance from the label.

In another embodiment the sheet of printed thermoplastic facestock is pre-printed before microperforating, thus minimizing label facestock removal during the printing process.

In another embodiment the microperforating allows the label to remain attached to the sheet while enhancing removal from the sheet by a user.

In another embodiment the labels are attached to shelving to display information about products.

In a still further embodiment an attachment frame is created to hold the shelf talker in position during use in cold or other extreme environments, such as heat, high humidity or the like. The frame may include a cohesive, magnetic ink or other fastening mechanisms. When a cohesive is utilized, a corresponding or matching pattern of cohesive is applied to the rear portion of the shelf talker so that the mating patterns, one on the shelf talker and one on the shelf will bond to one another. Similarly, a magnetic pattern of ink may be applied to the rear of the shelf talker label to magnetically attach the label to a shelf.

In a further exemplary embodiment of the presently described invention, a shelf marker system, is described and includes a shelf talker that has a facestock provided with an attachment feature; a shelf marker including a shelf having a corresponding attachment feature that is sized and configured to be in concert with the attachment feature on the facestock; a cover ply attached to the attachment feature of the facestock, the cover play and facestock having a depth; and a plurality of microperforations extending around the perimeter of the facestock and completely through the depth of the facestock and a full cut portion free of microperforations extending along a portion of the perimeter the full cut portion.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of a sheet of 8 individual labels constructed out of PET;

FIG. 2 is a side view of an individual label attached to a shelf edge surface;

FIG. 3 is a method for constructing a shelf talker comprised of PET;

FIG. 4 is a further method for constructing a shelf talker comprised of PET; and

FIG. 5 is a front view showing the shelftalker attached to a shelf using the attachment feature.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

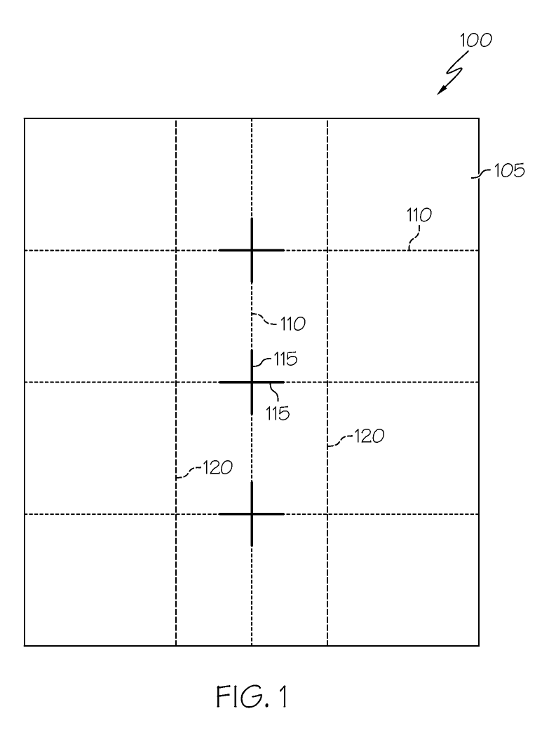

FIG. 1 shows a single sheet 100 that contains a plurality of printed polymer facestock labels 105 made out of PET or other polyester based material. The thickness of the PET or other polyester based material has an average range of 142 ga. The dimensions of one embodiment of the present invention provides for an 8.5 in by 11 in product whereas second embodiment provides a product having the dimensions of 8.5 in. by 14 in. The sheet 100 is mechanically microperforated 110 generally around the perimeter of the label 105 with a connecting portion of the perimeter having full cut 115 providing accessibility for removal of the label 105 from the sheet 100. Microperforations are comprised of a cut, the perforated portion of a piece of material, and a tie, the uncut portion of the material. Generally microperforations are approximately 0.012 in per cut and 0.008 in per tie. In total, this would equate to approximately 50 perforations per inch. The microperforations 110 and full cut 115 penetrate all layers of the sheet 100. The full cut 115 may be on any corner(s) or perimeter of the label 105 and be up to 50 percent of the perimeter. An additional face cut 120 partially penetrates the label 105 as a visual demarcation for applying the label 105 to a shelf or edge surface.

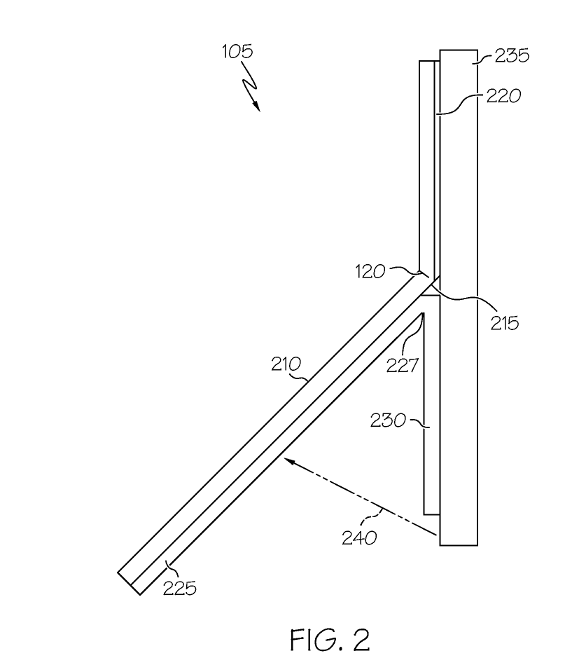

FIG. 2 shows a side view of a printed polymer facestock label 105 with a printed surface 210, and a back surface 215 with an adhesive 220, having a thickness of 0.75-1.25 mils is applied to the back surface 215 and a liner 225. While the foregoing embodiments describe a printed surface, the surface may also be blank and have no printing and may just use color to grab the attention of passersby. A tab 230 is peelable to the face cut 120 demarcation allowing for exposure to adhesive 220 for application to a shelf 235 or edge surface. The liner 225 having a front and back face is folded 227 away from the label 225 forming the tab 230. A possible embodiment of the present invention suggests a PET silicone release liner having a thickness of approximately 3 mil. Additionally, an anti-static layer can be added to the back face of the release liner. The exposed adhesive 220 under the tab 230 is adhered to the shelf 235 and the folded tab 230 is placed against the shelf 235 biasing 240 the label 105 away from the shelf 235 and toward the consumer enhancing label 105 visibility and functionality by making the label more prevalent.

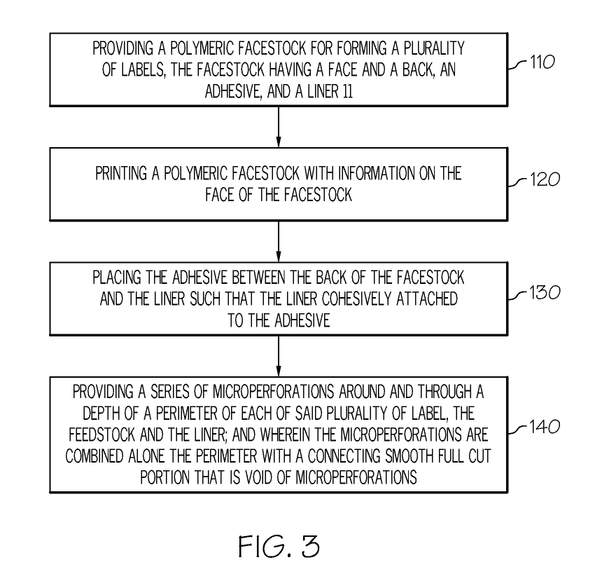

FIG. 3 describes a method of making a sheet of labels. A polymeric facestock is provided for forming a plurality of labels, the facestock having a face and a back 110. First, the polymeric facestock is printed with information on the face of the face stock 120. Secondly, adhesive is placed between the back of the facestock and a liner such that the liner is attached to the adhesive 130. Lastly, providing a series of microperforations around and through a depth of a perimeter of each of said the plurality of label the facestock and the liner; and wherein the microperforations are combined the perimeter with a connecting smooth full cut portion void of microperforations 140.

One embodiment of the claimed invention includes a shelf marker comprising a facestock with a pattern of adhesion having a perimeter that includes a metallic ink and magnetic ink perimeter, a liner cohesively attached to the pattern of adhesive, the liner adhesive and facestock having a depth; and a plurality of microperforation extending around the perimeter of the facestock and completely the depth and a full cut portion free of microperforations extending along a portion of the perimeter. A shelf marker may be fed through a high speed printer which Xerographically prints information onto the print receptive surface of the shelf marker.

Another possible embodiment of the claimed invention involves a mechanical fastener approach involving a shelf marker and shelf talker working in concert together. A shelf marker could contain a hook structure which allows attachment to a shelf talker having a loop structure. Alternatively a shelf marker could contain a loop structure and the shelf talker could contain a hook structure allowing for attachment of both the shelf talker and shelf marker.

One other embodiment of the claimed adhesive involves the use of cohesive instead of a pressure sensitive adhesive to secure a shelf talker to a shelf marker. With this embodiment, a cohesive would be applied around of the perimeter of the shelf marker so that the sheets can be properly fed through a printer. The cohesive would be printed on the back of the shelf marker as is done with the pressure sensitive adhesive. The cohesive utilized with this embodiment could be tack-free which would allow for a shelf marker to be constructed without a liner, however a liner could be used as a stiffener to ensure that the shelf marker lays flat on the shelf. Use of a cohesive would allow repeated use of the shelf marker to allow the cohesive to be re-activated with a new shelf talker. A corresponding cohesive pattern would be applied to the shelf area where the label is to be attached. The mating patterns of cohesive would form a bond sufficient to hold the label to the shelf.

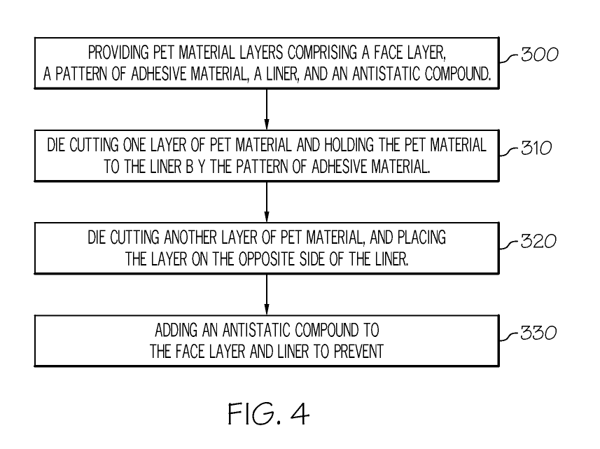

FIG. 4 describes the method for constructing a shelf talker made out of PET. A PET material is provided at step 300. Next, the layer is die cut at step 310 and held to a liner by a pattern of adhesive material. Another layer of material is cut at step 320 and placed on the opposite side of the liner. The second surface provides rigidity to the product. Additionally, in accordance with this method an antistatic compound may be added to the face layer at step 330 and liner to prevent static charge build up during the printing and processing of the material. This will prevent the “reactive curl” from which conventional shelf talkers suffer.

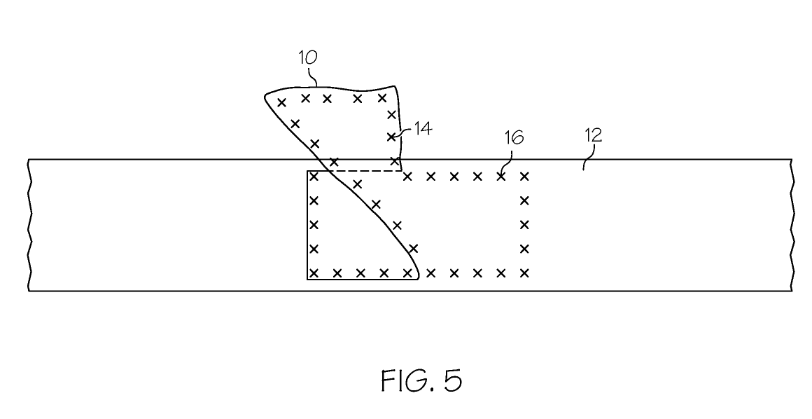

FIG. 5 illustrates the shelf talker 10 partially peeled away from a shelf 12. The shelf talker 10 includes a pattern 14 of an attachment feature that is intended to be secured to a mating pattern of an attachment feature 16 that has been disposed on a shelf 12. In the case of a magnetic ink, a mating pattern might not be needed if the shelf is constructed from metal, however, if the shelf is constructed from wood, plastic or other material where the magnetic ink would not attach, then a corresponding pattern of magnetic or metallic ink may be applied to the shelf. If a cohesive is used, there would need to be a pattern of cohesive on the back of the shelf talker and one on the shelf as is illustrated in FIG. 5. The patterns in FIG. 5 could also be mechanical fasteners such as a hook and loop fastener. The pattern may also be pressure sensitive adhesive, removable or repositionable adhesive, heat seal adhesives or any other suitable adhesives that may accomplish the function of attaching the shelf talker to the shelf.

It will thus be seen according to the present invention a highly advantageous advertising and imaged communication device has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

What is claimed is:

1. A sheet of printed labels, comprising;
a polymeric facestock having a front and a back with printed information in discrete, predefined areas on the facestock;
an attachment pattern is disposed on the back of the facestock, each of the discrete areas forming an individual label with each label having a perimeter such that the facestock includes microperforations that are around and completely through a depth of the perimeter of each of the labels; and
wherein the microperforations are combined along the perimeter of each of the labels with a connecting smooth full cut portion, and wherein the portion is void of the microperforations.

2. The sheet of printed labels as in claim 1, wherein the facestock is made out of polyethyelene terephthalate (PET).

3. The sheet of printed labels as in claim 1, wherein the attachment pattern is selected from a group including cohesive, magnetic ink and hook and loop fasteners.

4. The sheet of printed labels as in claim 1, wherein the PET facestock is approximately 142 ga thick.

5. The sheet of printed labels as in claim 1, wherein there are approximately 50 microperforations per inch.

6. The sheet of printed labels as in claim 1, wherein said the polymeric facestock is a thermoplastic material.

7. The sheet of printed labels as in claim 1, wherein the smooth full cut is along any length of the perimeter of the label.

8. The sheet of printed labels as in claim 1, wherein the facestock is face-cut allowing for peeling away the liner to a desired distance of the label.

9. The sheet of printed labels as in claim 1, wherein the label is attached to shelving and displays information about products.

10. A shelf marker system, comprising;
a shelf talker having a facestock provided with an attachment feature;
a shelf marker including a shelf having a corresponding attachment feature that is sized and configured to be in concert with the attachment feature on the facestock;
a cover ply attached to the attachment feature of the facestock, the cover play and facestock having a depth; and
a plurality of microperforations extending around the perimeter of the facestock and completely through the depth of the facestock and a full cut portion free of microperforations extending along a portion of the perimeter the full cut portion.

11. The shelf marker system as in claim 10, wherein the shelf marker is secured to the shelf talker.

12. The shelf marker system as in claim 10, wherein the attachment feature of the facestock is selected from a group including pressure sensitive adhesive, cohesive, magnetic ink, or hook and loop fasteners.

13. A shelf marker system, comprising;
a shelf talker having a facestock provided with an attachment pattern;
a shelf marker including a shelf having an attachment pattern that is sized and configured to be in concert with the attachment pattern on the facestock;
a liner attached to the attachment pattern, the liner and facestock having a depth; and
a plurality of microperforations extending around the perimeter of the facestock and completely through the depth and a full cut portion free of microperforations extending along a portion of the perimeter the full cut portion.

14. The shelf marker system as in claim 13, wherein the attachment pattern of one of the shelf talker or shelf marker includes a hook structure and another of the shelf talker or shelf marker includes a loop structure.

15. The shelf marker system as in claim 13, wherein the attachment pattern of each of the shelf talker and shelf marker includes a cohesive.

16. The shelf marker system as in claim 15, wherein the cohesive is tack-free.

17. A method of making a sheet of printed labels comprising:
providing a polymeric facestock for forming a plurality of labels, the facestock having a face and a back;
printing polymeric facestock with information on the face of the facestock;
placing adhesive between the back of the facestock and a liner such that the liner is cohesively attached to the adhesive; and
providing a series of microperforations around and through a depth of a perimeter of each of said the plurality of label, the feedstock and the liner; and wherein the microperforations are combined along the perimeter with a connecting smooth full cut portion, the cull cut portion being void of the microperforations.

18. The method of making a sheet of printed labels as in claim 17, wherein the polymeric feedstock is a thermoplastic.

19. The method of claim 17, wherein the labels are shelf talkers.
